(19) United States
(12) Patent Application Publication
(10) Pub. No.: US 2026/0183938 A1
(43) Pub. Date: Jul. 2, 2026

(54) ROBOT, ROBOT CONTROL SYSTEM, AND ROBOT CONTROL METHOD

(71) Applicant: LG ELECTRONICS INC., Seoul (KR)

(72) Inventors: Jaesung LEE, Seoul (KR); Woong JEONG, Seoul (KR); Beomseok CHAE, Seoul (KR); Hyunjai SHIM, Seoul (KR)

(73) Assignee: LG ELECTRONICS INC., Seoul (KR)

(21) Appl. No.: 19/131,691

(22) PCT Filed: Nov. 21, 2022
(86) PCT No.: PCT/KR2022/018387

§ 371 Date: May 21, 2025

(51) Int. Cl. B25J 9/16; B25J 13/06; G05D 1/223; G05D 1/224; G05D 1/226; G05D 1/617

(52) U.S. Cl. CPC B25J 9/1602; B25J 9/1689; B25J 9/1697; B25J 13/065; G05D 1/223; G05D 1/2246; G05D 1/226; G05D 1/617

(57) ABSTRACT

The present disclosure provides a robot control system comprising: a display; a communication unit; an input unit; and a processor, wherein the processor, when a remote travel mode is requested from a robot, determines whether to apply a remote assisted travel mode, receives, from the robot, a current state of the robot and sensor data measured by the robot, outputs a travelable area of the robot based on lidar sensor data, receives a destination of the robot from a user, calculates, based on the current state of the robot and the sensor data, linear speed and angular speed for moving the robot to the destination, predicts a path based on the linear speed and the angular speed, outputs the predicted path, and transmits a travel command to the robot based on speed data including the linear speed and the angular speed.

### TECHNICAL FIELD

The present disclosure relates to a robot, a control system of the robot, and a control method of the robot.

### BACKGROUND

A robot refers to a machine having human-like appearance and function or a mechanical device capable of operating with a single computer program (programmable) and automatically performing a complex series of actions.

An existing robot industry mainly focuses on an industrial robot, but recently, robots performing various functions are increasing with a recent robot technology development, a public interest in a use of the robots, and the like.

In particular, a mobile robot among the robots refers to a robot that is capable of moving and traveling while changing a location thereof by its own force. One of the biggest challenges in such a mobile robot corresponds to a traveling ability. To arrive at a desired destination, the mobile robot should be able to recognize a surrounding environment by itself, find a current location thereof, and establish a travel route plan based thereon.

In particular, as an autonomous driving technology of determining and operating by itself without human manipulation is applied to the robot, the robot has reached a level capable of traveling without human control.

However, even the robot capable of autonomous driving is in a situation where the autonomous driving is impossible because of various spatial or environmental factors.

To solve such problems, Prior art 1 (Korean Patent Publication No. 10-2022-0069699) relates to a remote control system of an electronic device, and discloses a configuration of connecting a robot device with a remote terminal, inputting whether to allow access of the remote terminal, and generating control information for controlling the robot device. However, there is no specific proposal for a method of generating a robot control command, and a method of responding to a change in a communication environment is also insufficient.

In addition, Prior Art 2 (Korean Patent Registration Number No. 10-2243244) relates to a control method based on an emergency step in an autonomous driving system, and discloses a configuration of sensing an object via a sensing unit to determine the emergency step based on a distance to the object, an expected collision time, an appearance event, and the like, transmitting sensing data based on the emergency step, and controlling a vehicle. However, there is a lack of specific details on a level of the emergency step, and a detailed control method based on the emergency step is not proposed.

### SUMMARY

### Technical Problem

A purpose of the present disclosure is to solve the above-described problems and other problems.

### Technical Solutions

According to an aspect of the present disclosure, provided is a system for controlling a robot including a display that outputs a screen, a communicator that transmits and receives data to and from at least one robot, an inputter that receives an input signal from at least one input device, and a processor that controls the display, the communicator, and the inputter, wherein the processor determines whether to apply a remote assisted driving mode included in a remote driving mode when receiving a request for the remote driving mode from the robot, receives a current state of the robot and sensor data measured by the robot from the robot when the remote assisted driving mode is applied, outputs a travelable area of the robot on the display based on LiDAR sensor data included in the sensor data, receives a destination of the robot from a user via the input device, calculates a linear velocity and an angular velocity for moving the robot to the destination based on the current state of the robot and the sensor data, predicts a route based on the linear velocity and the angular velocity, outputs the predicted route on the display, and transmits a travel command to the robot based on velocity data including the linear velocity and the angular velocity.

The processor may predict the route based on data collected via an odometry sensor included in the robot, a dynamic state of the robot, and a delay state of the robot.

The processor may receive a prohibited area from the user, and transmit the travel command to the robot based on the prohibited area.

The route may be a route travelable by the robot within a first time period based on a size of the robot and the velocity data.

The processor may generate the travelable area using Bresenham's line algorithm and a flood fill algorithm.

The processor may periodically check a state of communication with the robot.

The processor may perform at least one of a hole punching process, a heartbeat transmission/reception process, and a process of checking a response time for a delay characteristic message to check the state of communication with the robot.

The processor may stop receiving image data from the robot when the state of communication with the robot is an abnormal state.

The processor may limit a maximum velocity of the robot when the state of communication with the robot is an abnormal state.

The processor may control the robot in a remote manual driving mode when the input device is a joystick, wherein the remote manual driving mode is included in the remote driving mode, and control the robot in the remote assisted driving mode when the input device is a mouse or a keyboard.

According to another aspect of the present disclosure, provided is a method for controlling a robot including requesting a remote driving mode, determining whether to apply a remote assisted driving mode included in the remote driving mode, receiving a current state of the robot and sensor data measured by the robot from the robot when the remote assisted driving mode is applied, outputting a travelable area of the robot based on LiDAR sensor data included in the sensor data, receiving a destination of the robot from a user, calculating a linear velocity and an angular velocity for moving the robot to the destination based on the current state of the robot and the sensor data, predicting a route based on the linear velocity and the angular velocity, outputting the predicted route, and transmitting a travel command to the robot based on velocity data including the linear velocity and the angular velocity.

According to still another aspect of the present disclosure, provided is a robot including a sensor that collects sensor data, a communicator that transmits and receives data to and from a system for controlling the robot, and a processor that controls the sensor and the communicator, wherein the processor requests a remote driving mode from the control system of the robot, transmits the collected sensor data to the control system of the robot, and travels based on a linear velocity and an angular velocity included in velocity data received from the control system of the robot.

### Advantageous Effects

Effects of the robot, the control system of the robot, and the control method of the robot according to the present disclosure will be described as follows.

According to an embodiment of the present disclosure, the limitation of the autonomous driving of the robot may be overcome via the remote control with the low-delay transmission and reception of the Internet image and the sensor data.

According to an embodiment of the present disclosure, the remote driving control reflecting the intention of the operator may be available.

According to an embodiment of the present disclosure, the driving performance and obstacle avoidance effort based on the experience and the proficiency of the operator may be minimized.

According to an embodiment of the present disclosure, the management in the system may be minimized by linking the autonomous driving software to the technology processed in the remote control.

According to an embodiment of the present disclosure, the multiple robots may be remotely controlled on the Internet in the same manner, thereby facilitating maintenance, repair, and expansion.

Effects obtainable in the present disclosure are not limited to the effects mentioned above, and other effects not mentioned will be clearly understood by those skilled in the art to which the present disclosure pertains from the following description.

### BRIEF DESCRIPTION OF THE DRAWINGS

FIG. 1 is a block diagram illustrating a structure of robot according to an embodiment of the present disclosure.

FIG. 2 is a block diagram illustrating a configuration of a robot and a control system of the robot according to an embodiment of the present disclosure.

FIG. 3 is a diagram illustrating a method for controlling a robot according to an embodiment of the present disclosure.

FIG. 4 is a diagram illustrating an embodiment in which a remote driving mode is required for a robot according to an embodiment of the present disclosure.

FIG. 5 illustrates an embodiment of operating in a remote manual driving mode of a robot according to an embodiment of the present disclosure.

FIG. 6 illustrates an embodiment of operating in a remote assisted driving mode of a robot according to an embodiment of the present disclosure.

FIG. 7 is a diagram illustrating an algorithm for generating a travelable area in a control system of a robot according to an embodiment of the present disclosure.

FIG. 8 is a diagram illustrating an embodiment of setting a destination in a control system of a robot according to an embodiment of the present disclosure.

FIGS. 9A to 9C are diagrams illustrating an example of using a robot and a control system of the robot according to an embodiment of the present disclosure.

FIGS. 10A to 10C are diagrams illustrating an obstacle processing embodiment of a robot and a control system of the robot according to an embodiment of the present disclosure.

FIG. 11 is a diagram illustrating a user interface output by a control system of a robot according to an embodiment of the present disclosure.

FIGS. 12A and 12B are diagrams illustrating a user interface output by a control system of a robot according to another embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function.

In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another. It will be understood that when an element is referred to as being “connected with” another element, the element can be directly connected with the other element or intervening elements may also be present.

In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

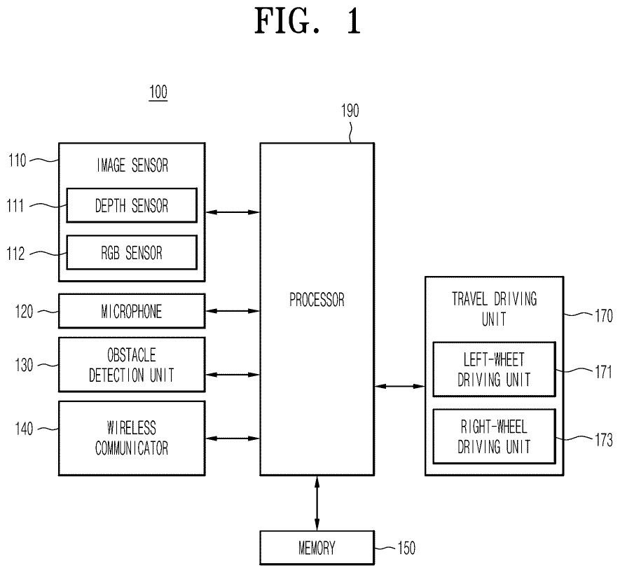

FIG. 1 is a block diagram illustrating a structure of robot according to an embodiment of the present disclosure.

Referring to FIG. 1, the robot 100 according to an embodiment of the present disclosure may include an image sensor 110, a microphone 120, an obstacle detector 130, a wireless communicator 140, a memory 150, and a travel driver, and a processor 190.

The image sensor 110 may acquire image data about the surroundings of the robot 100. The image sensor 110 may include one or more of a depth sensor 111 and an RGB sensor 113.

The depth sensor 111 may detect that light emitted from a light emitter (not shown) is reflected from an object and returned. The depth sensor 111 may measure a distance to the object based on a time difference between a light emission time and a light reception time, the intensity of returned light (received light), and the like. The depth sensor 111 may acquire two-dimensional (2D) or three-dimensional (3D) image information about the surroundings of the robot 100 based on the measured distance between objects.

The RGB sensor 113 may obtain color image information about objects around the robot 100. The color image information may be a captured image of each object. The RGB sensor 113 may be referred to as an RGB camera.

The microphone 120 may receive a user's voice. The received voice of the user may be analyzed through a voice server (not shown). At this time, the user's voice may be a voice signal for controlling the robot 100.

The obstacle detector 130 may include an ultrasonic sensor, an infrared sensor, a laser sensor, etc. For example, the obstacle detector 130 may irradiate laser light to a cleaning area, and may extract a pattern of the reflected laser light. The obstacle detector 130 may detect one or more obstacles based on the position and pattern of the extracted laser light. When the depth sensor 110 is used to detect the obstacle, the configuration of the obstacle detector 130 may be omitted.

The wireless communicator 140 may include at least one of a wireless Internet module and a short-range communication module.

The mobile communication module may transmit and receive radio frequency (RF) signals (also called wireless signals) to and from at least one of a base station (BS), an external user equipment (UE), and a server over a mobile communication network constructed according to technical standards for mobile communication or communication methods (for example, GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), etc.).

The wireless Internet module may refer to a module for wireless Internet access, and may be embedded in or external to the terminal 100. The wireless Internet module 113 is configured to transmit and receive RF signals over a communication network according to wireless Internet technologies.

The wireless Internet technology may include, for example, Wireless LAN (WLAN), Wi-Fi, Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), etc.

The short-range communication module may be configured to facilitate short-range communications. Suitable technologies for implementing such short-range communications include BluetoothTM, Radio Frequency IDentification (RFID), Infrared Data Association (IrDA), Ultra-WideBand (UWB), ZigBee, Near Field Communication (NFC), Wi-Fi, Wi-Fi Direct, Wireless Universal Serial Bus (Wireless USB), and the like.

The memory 150 may store a simultaneous localization and mapping (SLAM) map created through a simultaneous localization and mapping (SLAM) algorithm.

The movement detection sensor 160 may detect the movement of the robot 100. Specifically, the movement detection sensor 160 may detect that the robot 100 is lifted and moved by the user. The movement detection sensor 160 may include at least one of a floor detection sensor 161 and a gyro sensor 163.

The floor detection sensor 161 may detect whether the robot 100 has moved by the user using infrared rays. A detailed description thereof will be given later with reference to the attached drawings.

The gyro sensor 163 may measure the angular velocity of the robot 100 for each of X-axis, Y-axis, and Z-axis. The gyro sensor 163 may detect movement of the robot 100 by the user using the amount of change in angular velocity for each axis.

In addition, the movement detection sensor 160 may further include a wheel sensor, a cliff sensor, etc., and may be used to detect movement of the robot 100 by the user.

The travel driver 170 may move the robot 100 toward a specific direction or may move the robot 100 by a specific distance. The travel driver 170 may include a left-wheel driver 171 for driving a left wheel of the robot 100 and a right-wheel driver 173 for driving a right wheel of the robot 100.

The left-wheel driver 171 may include a motor for driving the left wheel, and the right-wheel driver 173 may include a motor for driving the right wheel.

Although FIG. 1 has disclosed the travel driver 170 including both the left-wheel driver 171 and the right-wheel driver 173 as an example, the scope of the present disclosure is not limited thereto, and it should be noted that, if there is only one wheel, only one driver may be provided.

The processor 190 may control the overall operation of the robot 100.

A situation in which remote control is required for the robot, that is, a situation in which autonomous driving is impossible, is as follows.

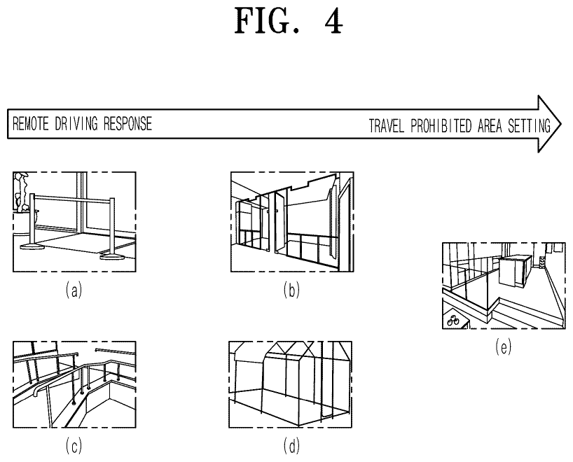

For example, in an indoor/outdoor conversion section, a narrow space, and a human-level cognition required environment, travel is impossible only by the autonomous driving of the robot. In particular, in a process of providing an indoor/outdoor mobility service of the robot, button manipulation is required in an elevator, a front entrance, an automatic door, and the like, but an autonomous manipulation technology is not sufficiently mature, which acts as an obstacle to business expansion. This will be described in detail in FIG. 4.

In addition, when there is a difficulty in generation of a grid map and a topology map, when an environment has been changed but an existing map has not been updated, when it is an GPS weak area or a localization problem (insufficiency of sensor data of an odometry sensor or a LiDAR) occurs, the autonomous driving of the robot becomes difficult.

In addition, there may be a case in which a control system needs to respond to a remote control situation with a small workforce in a consistent and minimal effort for multiple robots. This will be described in more detail in following drawings.

In this case, existing approaches have focused on performing manual remote control based on a low-delay image and a sensor, implementing communication environment response and quality of service (QOS) policies, and realizing a realistic image that simulates a driver's seat, such as stitching correction, distortion correction, and 3D/AR.

However, in this case, the control system has no choice but to operate the robot based on an operator experience using information provided by a dashboard. In addition, a response to a dynamic obstacle also depends on responsiveness of the operator, and the operator depends on resolution and delay of a front image. Finally, there is a problem that a remote control performance is determined by proficiency of the operator and there is a limit to the response of the multiple robots.

That is, to overcome spatial or environmental limitations of the indoor and outdoor autonomous driving robot, the remote control in the control system is essential.

In general, when the autonomous driving is difficult because of a problem occurred during the autonomous driving, the remote control is requested, and the control system performs manual driving based on image information transmitted from the robot, and hands over a control right to the robot again via the autonomous driving after solving the problem.

For more effective remote driving, it is intended to propose a remote assisted driving mode in addition to the manual remote control that may make the remote control easier by utilizing sensor information received from the robot. Such an embodiment is applicable to the robot, especially an indoor and outdoor delivery robot, in an LTE/5G communication network.

A purpose of the present disclosure is to transmit the sensor data to the control system and perform the remote control of the robot in the control system, but to minimize operation of the operator.

The remote control performance is affected by the proficiency of the operator and effort put into one robot is too great to control the multiple robots in one control system. To prevent this, it is intended that the control system processes the sensor data together with the image information, generates a necessary command, and transmits the command to the remote robot.

By adding the remote assisted driving mode, the impact related to the proficiency of the operator may be minimized. In addition, there is an advantage that responding to the multiple robots is also possible with minimal remote driving intervention.

To this end, an assisted remote control method is intended to be constructed via low-delay data communication, user input environment construction, and operation in the control system even for a minimum network band.

Roughly, a method for controlling a robot proposed by the present disclosure is as follows.

First, a manual driving mode and an autonomous driving mode capable of travel under control of the robot, and a remote manual driving mode and the remote assisted driving mode capable of travel under control of the control system are included. In this regard, the remote manual driving mode and the remote assisted driving mode may be collectively referred to as a remote driving mode.

More specifically, in the manual driving mode, the robot may be viewed with the naked eye and controlled as a linear velocity and an angular velocity are input by an input device wirelessly connected to the robot. In this case, there is a problem that the input device such as a joystick is required and the control should be performed near the robot.

In addition, in the autonomous driving mode, the robot has already built a map and a location of the robot on the map may be estimated. Thereafter, when a destination is determined based on a user input, the robot may travel by finding the shortest distance in the map, finding an optimal route within a short distance of the robot itself, and generating a linear velocity and an angular velocity. In this case, the robot should be able to estimate the location on the map and make a route plan required for the autonomous driving.

In addition, the remote manual driving mode is a mode in which the robot transmits an image of the robot or the sensor data to a remote place in real time, and the user inputs a linear velocity and an angular velocity via an input device connected to a remote PC and controls the robot while viewing a screen. In this case, a low-delay real-time data transmission function, a service response function based on a network condition check, and a configuration of the image and the sensor data that the user may identify remotely are required.

Finally, it is the remote assisted driving mode. The remote assisted driving mode is a mode in which the robot transmits the image of the robot or the sensor data to the remote place in real time and processes and outputs the map in a form that is easy for the user to control, and when a location within a travelable range is specified by the user's input device, a linear velocity and an angular velocity are calculated and a command is transmitted to the robot. Like the remote manual driving mode, the low-delay real-time data transmission function, the service response function based on the network condition check, an interface through which the user may input the destination, a short-range route planning function, and the like are required.

Accordingly, the control system may help the robot travel while recognizing and avoiding an obstacle therearound on its own. Further, even when map information is not known, the remote control may be performed by automatically avoiding the obstacle with the sensor data and an odometry (dead-reckon) value. In addition, by displaying a movable area of the robot in addition to displaying the pure sensor data, the control of the operator may be facilitated.

The present disclosure will be described in more detail with reference to following drawings.

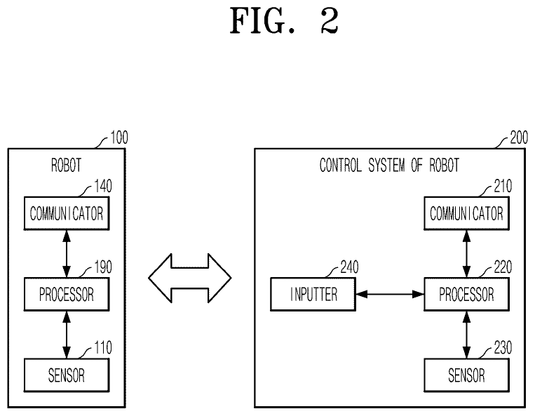

FIG. 2 is a block diagram illustrating a configuration of a robot and a control system of the robot according to an embodiment of the present disclosure. Hereinafter, a description redundant with the above-described content will be omitted.

Referring to FIG. 2, the robot 100 may include the communicator 140, the sensor 110, and the processor 190. A detailed description of the robot 100 may refer to FIG. 1.

The communicator 140 may transmit and receive data to and from a control system 200 of the robot.

The sensor 110 may collect surrounding environment information of the robot 100 as the sensor data. Here, the sensor 110 may further include an odometry sensor and a LiDAR sensor in addition to the sensor described above in FIG. 1. The odometry sensor, as a sensor designed to measure a distance traveled by the robot, may obtain the distance by multiplying the number of rotations of a wheel and a tire circumference, and may provide wheel velocity values to various robots, including those with ABS.

The control system 200 of the robot may include a communicator 210, a processor 220, a display 230, and an inputter 240. Here, the control system 200 of the robot may include hardware, for example, a PC, a terminal, or the like. In addition, an operation of the processor 220 in the control system 200 of the robot may be included in the present disclosure as a method for controlling the robot.

The communicator 210 may transmit and receive the data to and from at least one robot. In this regard, the control system 200 of the robot may receive the sensor data collected in the robot 100 from the robot 100.

The display 230 may output a screen. When receiving a current state of the robot 100 and the sensor data measured by the robot 100 from the robot 100, the control system 200 of the robot may output the travelable area of the robot 100 based on the received data.

The inputter 240 may receive the user input. For example, the inputter 240 may include a mouse, a keyboard, a joystick, and the like. That is, when the user makes the input to the control system 200 of the robot via the mouse, the processor 220 may receive the input. The data collected by the inputter 240 may be analyzed and processed as a control command of the user.

The processor 220 may control the communicator 210, the display 230, and the inputter 240, and may control overall operations of the robot 100 and the control system 200 of the robot. In an embodiment, the processor 220 may periodically check a state of communication with the robot 100. More specifically, the check of the state of communication with the robot 100 by the processor 220 may include a hole punching process for Internet connection, a heartbeat transmission/reception process for connection maintenance, and a process of checking a response time to a delay characteristic message for identifying a delay characteristic.

In addition, in an embodiment, when the state of communication with the robot 100 is not smooth, that is, in an abnormal state, as a result of checking the state of communication with the robot 100, the processor 220 may stop receiving the image data from the robot 100. More specifically, the control system 200 of the robot may receive data on a current state of the robot 100 and the various sensor data from the robot 100. In this regard, the control system 200 of the robot may receive only a minimum amount of LiDAR sensor data from the robot 100 and stop receiving other image data having a high traffic demand. In addition, the control system 200 of the robot transmits only a minimum control command (velocity data including the angular velocity and the linear velocity) to the robot 100 and maintains a real-time property between the robot 100 and the control system 200 of the robot.

In addition, in another embodiment, when the state of communication with the robot 100 is not smooth, that is, in the abnormal state, as the result of checking the state of communication with the robot 100, the processor 220 limits a maximum velocity for controlling the robot 100 and secures a control margin.

Hereinafter, the operation performed by the control system 200 of the robot may be performed by calculation of the processor 220, but for convenience of description, it will be described that the control system 200 of the robot performs the operation.

In addition, in the robot 100 and the control system 200 of the robot in FIG. 2, only the components essential to describe the present disclosure are illustrated. It goes without saying that obvious components required for operating the general robot 100 and the control system 200 of the robot may be used to implement an embodiment of the present disclosure even though they are not illustrated.

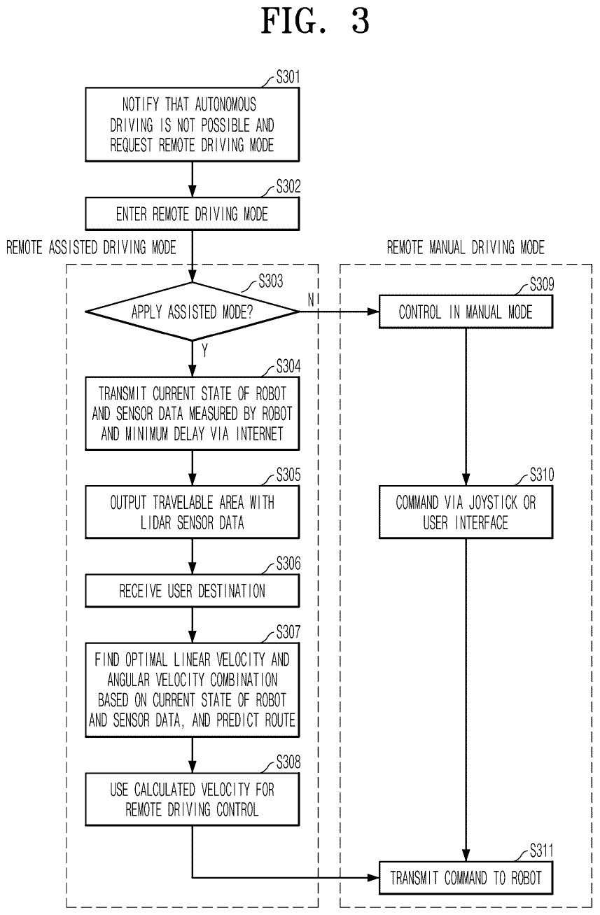

FIG. 3 is a diagram illustrating a method for controlling a robot according to an embodiment of the present disclosure. Hereinafter, a description redundant with the above-described content will be omitted.

Referring to FIG. 3, in step S301, the robot may notify the control system of the robot that the autonomous driving is not possible and request the remote driving control therefrom. In this regard, the robot may determine by itself that the autonomous driving is not possible. An embodiment in which the robot notifies that the autonomous driving is not possible and requests the remote driving will be described in detail in FIG. 4.

In step S302, the robot may enter the remote driving mode. In this regard, the control system of the robot may output a user interface for entering the remote driving mode of the robot. A content of the user interface output from the control system of the robot will be described in detail in following drawings.

In step S303, the control system of the robot may determine whether to apply the remote assisted driving mode of the robot. When the control system of the robot determines that the remote assisted driving mode is able to be applied to the robot, step S304 may be performed, and when the control system of the robot determines that the remote assisted driving mode is not able to be applied to the robot, step S309 may be performed.

In step S304, when the remote assisted driving mode is applied, the control system of the robot may receive the current state of the robot and the sensor data measured by the robot from the robot. In this regard, the control system of the robot may receive current relative location data via the odometry sensor and the sensor data via the LiDAR sensor from the robot. In this regard, the robot may transmit the current state of the robot and the sensor data measured by the robot to the control system of the robot with a minimum delay (50 ms) via the Internet.

In step S305, the control system of the robot may output the travelable area of the robot with the LiDAR sensor data.

In step S306, the control system of the robot may receive an input corresponding to the destination of the user in the output travelable area of the robot.

In step S307, the control system of the robot may find an optimal linear velocity and angular velocity combination based on the current state of the robot and the sensor data, and predict a route of the robot. That is, the control system of the robot may calculate an optimal route based on the relative location data, the sensor data, and the destination received from the robot.

In step S308, the control system of the robot may use the calculated velocity (including the linear velocity and the angular velocity) for the remote driving control.

In step S309, when the remote manual driving mode is applied, the user may control the robot in the manual mode using the control system of the robot.

In step S310, the user may control the robot via the joystick or the user interface that is the input device of the control system of the robot.

In step S311, the control system of the robot may transmit the data (including the linear velocity and the angular velocity) received via the input device of operation S310 to the robot. In addition, the control system of the robot may transmit the velocity data (including the linear velocity and the angular velocity) calculated via step S308 to the robot. In this regard, the control system of the robot may convert the data of step S310 and the data of step S308 into a control command recognizable by the robot and instruct the robot.

When the autonomous driving mode of the robot and the remote assisted driving mode of the control system of the robot may cover a large portion of the travel of the robot, even when several robots request the remote driving mode, one person will be able to control them.

FIG. 4 is a diagram illustrating an embodiment in which a remote driving mode is required for a robot according to an embodiment of the present disclosure. Hereinafter, a description redundant with the above-described content will be omitted.

(a) to (d) in FIG. 4 illustrate an embodiment in which the robot or the control system of the robot is notified that the autonomous driving of the robot is not possible and should switch to the remote driving mode, and (e) in FIG. 4 illustrates an area in which the robot should not travel.

More specifically, when there is an entrance/exit with a belt-type blocking bar as shown in (a) in FIG. 4, a transparent structure that is difficult for the robot to sense as shown in (b) in FIG. 4, a ramp with a handrail as shown in (c) in FIG. 4, and a frame structure as shown in (d) in FIG. 4, the robot does not perform the autonomous driving but performs the remote driving. In this regard, as shown in FIG. 3, the robot requests the remote driving from the control system of the robot, or the control system of the robot autonomously performs the remote driving of the robot. In particular, in the past, in a situation where such remote driving is requested, the robot is operated in the remote manual mode, and the user controls the robot using the input device such as the joystick, but according to the present disclosure, because the remote assisted driving mode is available, the user may more easily control the robot.

(e) in FIG. 4 corresponds to a situation in which a staircase structure on which the robot should not travel exists. When the staircase exists, the robot or the control system of the robot may set the staircase as an area in which the robot should not travel.

In addition to (a) to (d) in FIG. 4, situations in which the autonomous driving of the robot is not possible are as follows.

As situations caused by an external environment, there are cases where there is no map of a place where the robot is located, where the map of the place where the robot is located has been changed, and where a travel environment has been changed because of a temporary installation resulted from construction or control at the place where the robot is located.

In addition, as situations caused by an error in the robot, there are cases where the autonomous driving is not possible because of a malfunction of the sensor required for the autonomous driving, where an emergency response is required because of an error or a malfunction of the robot system, and where it is difficult to return to a starting point because of low battery of the robot.

In addition, the control system of the robot or the user using the control system of the robot may directly request intervention. This includes cases where the robot approaches an area of interest and thus needs to be observed or checked while being monitoring and where the robot deviates from a specified route and thus needs to be monitored or observed.

In these cases, the robot or the control system of the robot may utilize the present disclosure.

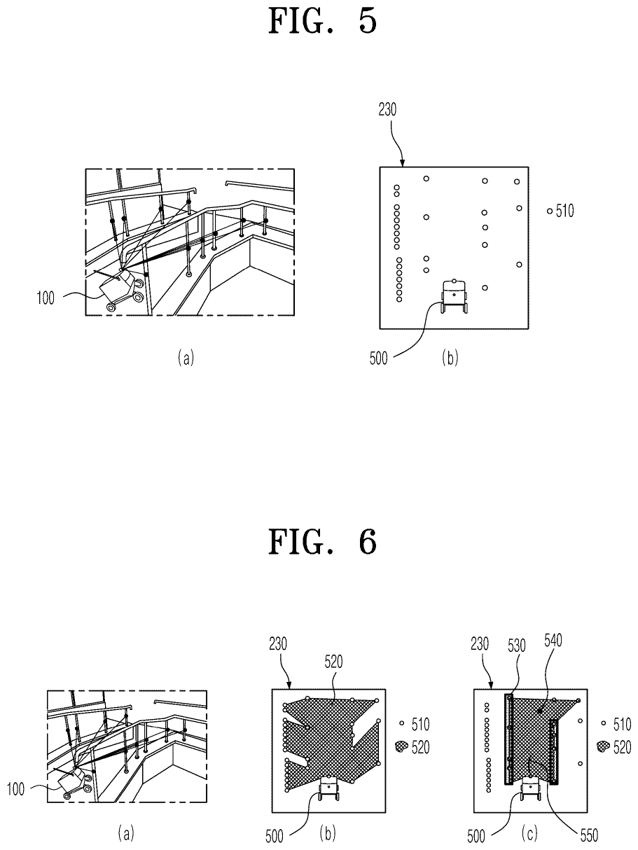

FIG. 5 illustrates an embodiment of operating in a remote manual driving mode of a robot according to an embodiment of the present disclosure. Hereinafter, a description redundant with the above-described content will be omitted.

Referring to (a) in FIG. 5, the robot 100 may sense the ramp with the handrail installed. In this regard, the robot 100 may recognize a pillar of the handrail as an obstacle.

In this regard, the robot 100 may request the existing remote manual driving mode from the control system of the robot. Accordingly, the control system of the robot may output a screen as shown in (b) in FIG. 5 via the display 230.

In an embodiment, the control system of the robot may output an icon 500 corresponding to the current location of the robot 100 and an indicator 510 corresponding to the obstacle via the display 230. Accordingly, the user may control the robot 100 to avoid the obstacle using the joystick, which is one of the input devices.

Therefore, in this remote manual driving mode, a control ability of the user using the control system of the robot is required. To easily use the control system of the robot even by a user without the control ability, the present disclosure proposes the remote assisted driving mode as shown in FIG. 6.

FIG. 6 illustrates an embodiment of operating in a remote assisted driving mode of a robot according to an embodiment of the present disclosure. Hereinafter, a description redundant with the above-described content will be omitted.

(a) in FIG. 6 illustrates the same situation as in (a) in FIG. 5. That is, the robot 100 may sense the ramp with the handrail installed.

Referring to (b) in FIG. 6, the control system of the robot may output the icon 500 corresponding to the current location of the robot 100 and the indicator 510 corresponding to the obstacle via the display 230.

In an embodiment of the present disclosure, the control system of the robot may indicate a travelable area 520 based on the obstacle. In this regard, the control system of the robot may utilize the image and the LiDAR data received from the robot 100. The control system of the robot may recognize a travel situation at the current location of the robot 100 based on the image and the LiDAR data.

Referring to (c) in FIG. 6, the control system of the robot may output a virtual barrier 530 based on the obstacle. The control system of the robot may output the virtual barrier 530 based on the sensed obstacle, which may be manually selected by the user of the control system of the robot. For example, the user may drag and drop the mouse to set the virtual barrier 530 in consideration of the icon 510 corresponding to the obstacle output on the display 230.

Thereafter, the control system of the robot may receive an input signal for a destination 540 from the user. The user may click the destination 540 in the travelable area 520 output on the display 230 with the mouse. In an embodiment, the control system of the robot may output an expected movement route 550 of the robot 100 based on the destination 540, and transmit a command for controlling the robot 100 based on the expected movement route 550 to the robot 100.

Accordingly, the control system of the robot has an advantage in that the robot 100 may be easily controlled via the simple mouse manipulation regardless of the user's control ability.

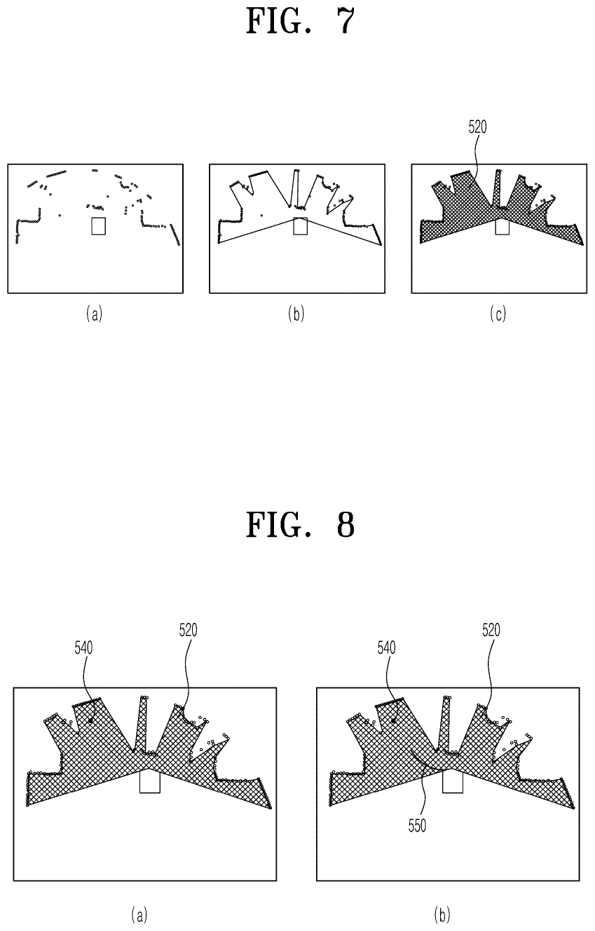

FIG. 7 is a diagram illustrating an algorithm for generating a travelable area in a control system of a robot according to an embodiment of the present disclosure. Hereinafter, a description redundant with the above-described content will be omitted.

(a) in FIG. 7 illustrates raw data of the LiDAR data transmitted by the robot. In this regard, the robot may collect the raw data via the LiDAR sensor. The robot may collect about 820 sampling data up to 25 meters in front within a 270-degree horizontal angle range from a sick LiDAR at a scanning frequency of 15 Hz.

However, the raw data as shown in (a) in FIG. 7 is difficult for the user to understand. Therefore, for user's convenience, the control system of the robot uses algorithms as shown in (b) and (c) in FIG. 7.

(b) in FIG. 7 illustrates an algorithm for the control system of the robot to generate a closed loop area based on the LiDAR data received from the robot. Here, the control system of the robot may generate the closed loop area based on the obstacle using Bresenham's line algorithm.

(c) in FIG. 7 illustrates an algorithm for the control system of the robot to generate the travelable area 520 based on the generated closed loop area. Here, the control system of the robot may generate the closed loop space generated in (b) in FIG. 7 as the travelable area 520 using a flood fill algorithm.

That is, the control system of the robot may extract data on the travelable area 520 where the robot may go from the current location via the Bresenham's line algorithm and the flood fill algorithm.

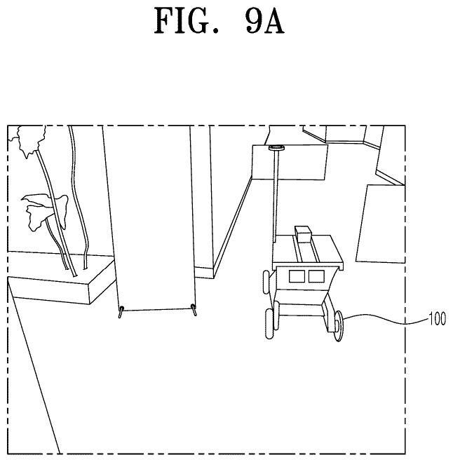

FIG. 8 is a diagram illustrating an embodiment of setting a destination in a control system of a robot according to an embodiment of the present disclosure. Hereinafter, a description redundant with the above-described content will be omitted.

Referring to (a) in FIG. 8, the control system of the robot may receive the destination 540 from the user in the travelable area 520 generated through (c) in FIG. 7 and output an indicator corresponding to the destination 540. In this regard, the control system of the robot may not issue a command for the entire movement route of the robot, but may issue a command only up to a front 2 m level of the robot.

Referring to (b) in FIG. 8, the control system of the robot may output the expected movement route 550 for the robot to travel to the destination 540. In this regard, the expected movement route 550 is an expected route when the robot moves at the linear velocity and the angular velocity included in the control command, and the entire route to the destination 540 is not planned.

More specifically, the control system of the robot may calculate a reachable range within a first time period (e.g., within 10 seconds) using static conditions such as a width and a length of the robot itself and maximum linear velocity and angular velocity that the robot may output. The control system of the robot may output the expected movement route 550 based on the calculated velocity data, and may control the robot by transmitting the velocity data to the robot.

In addition, the control system of the robot may receive the input regarding the destination 540 with the mouse, which indicates the remote assisted driving mode. The user is able to control the robot using the joystick even after inputting the destination 540 via the mouse. In this regard, the control system of the robot may execute the remote manual driving mode when the user starts to control the robot using the joystick.

In an embodiment, the control system of the robot may process the signal received from the mouse and the signal received from the joystick differently, but may control the robot by transmitting only the velocity data of the linear velocity and the angular velocity to the robot.

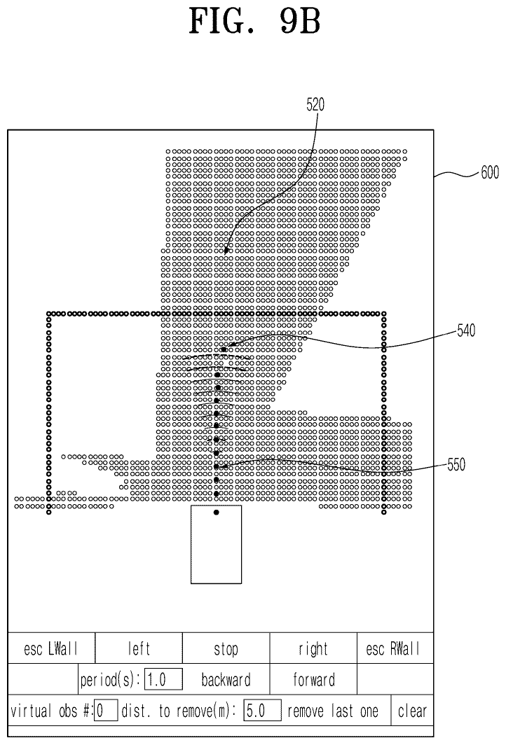

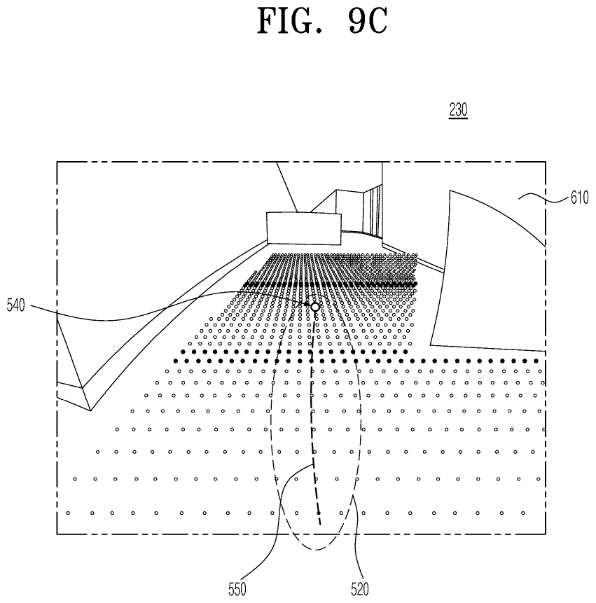

FIGS. 9A to 9C are diagrams illustrating an example of using a robot and a control system of the robot according to an embodiment of the present disclosure. Hereinafter, a description redundant with the above-described content will be omitted.

FIG. 9A illustrates a state in which the robot 100 is actually traveling, FIG. 9B illustrates a 2D LiDAR view 600 of the control system of the robot, and FIG. 9C illustrates a camera view 610 output by the control system of the robot on the display. In this regard, the control system of the robot may output at least one of the 2D LiDAR view 600 in FIG. 9B and the camera view 610 in FIG. 9c on the display 230.

Referring to FIG. 9A, the robot 100 may collect data regarding a surrounding environment via the LiDAR sensor while traveling.

Referring to FIG. 9B, the control system of the robot may receive the data collected via the LiDAR sensor from the robot 100. In an embodiment, the control system of the robot may generate the 2D LiDAR view 600 based on the received data.

In an embodiment, the control system of the robot may output the travelable area 520 via the 2D LiDAR view 600. In this regard, an embodiment of generating the travelable area 520 is as described above.

When receiving the destination 540 from the user, the control system of the robot may output the indicator corresponding to the destination 540 on the 2D LiDAR view 600. Similarly, when receiving the destination 540, the control system of the robot may output the expected movement route 550 reflecting an optimal velocity calculated within a preset time period (e.g., within a few seconds) on the 2D LiDAR view 600.

However, even in this case, the 2D LiDAR view 600 output by the control system of the robot may not be familiar to the user. Accordingly, for user convenience, the control system of the robot may output the camera view 610 as shown in FIG. 9C on the display 230.

More specifically, the control system of the robot may generate the camera view 610 based on the image data and the LiDAR data received from the robot. In this regard, the control system of the robot may output a 3D image that allows the user to directly view the traveling situation of the robot based on the image data received from the robot, and output the travelable area 520 in the 3D image based on the LiDAR data collected by the robot.

The control system of the robot may receive the destination 540 from the user and output the expected movement route 550 for the robot to travel to the destination 540 on the camera view 610.

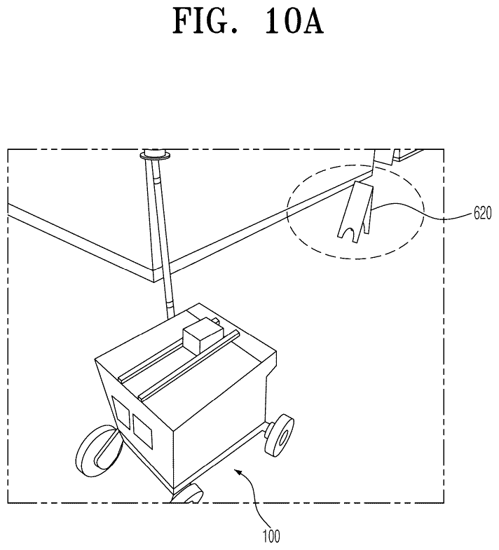

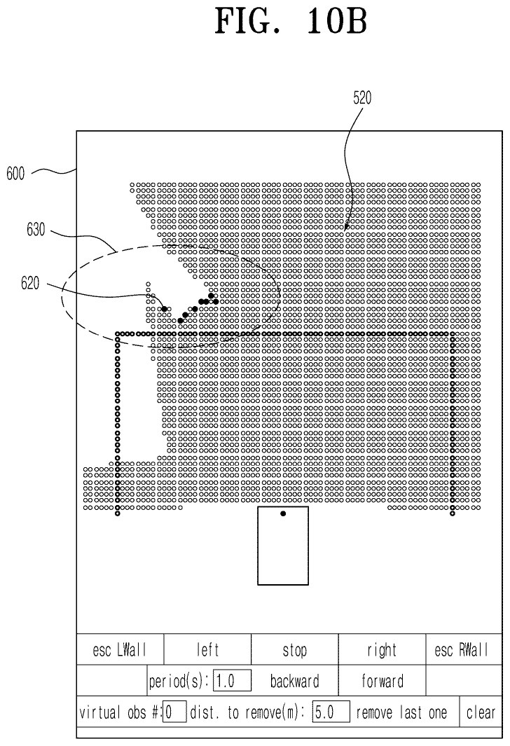

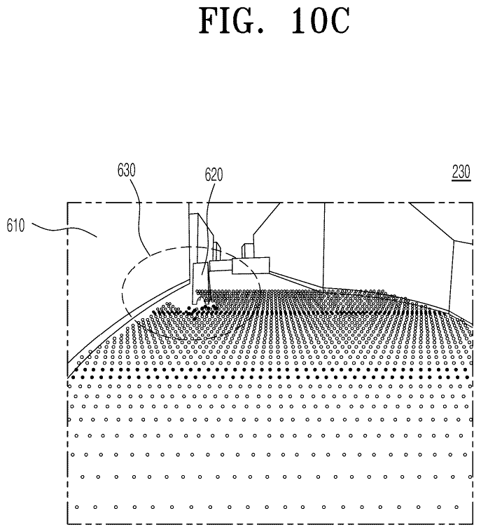

FIGS. 10A to 10C are diagrams illustrating an obstacle processing embodiment of a robot and a control system of the robot according to an embodiment of the present disclosure. Hereinafter, a description redundant with the above-described content will be omitted.

As described above, FIG. 10A illustrates the state in which the robot 100 is actually traveling, FIG. 10B illustrates the 2D LiDAR view 600 of the control system of the robot, and FIG. 10C illustrates the camera view 610 output by the control system of the robot on the display 230.

Referring to FIG. 10A, the robot 100 may collect the data regarding the surrounding environment via the LiDAR sensor while traveling. In this regard, although an obstacle 620 exists within a travelable range of the robot 100, the LiDAR sensor of the robot 100 may not sense the obstacle 620.

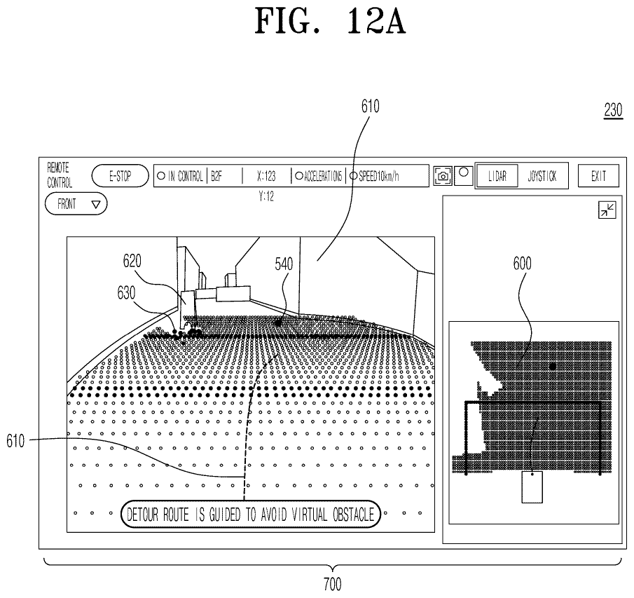

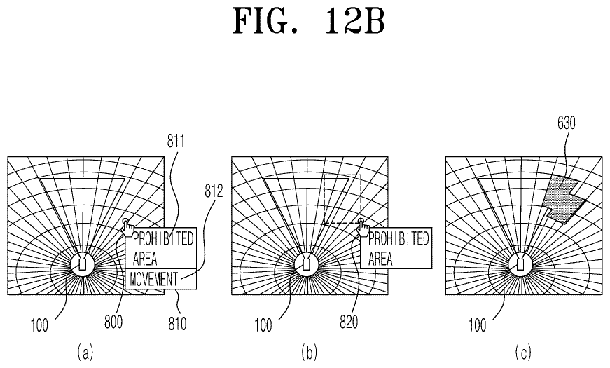

In this regard, the control system of the robot according to an embodiment of the present disclosure may set a prohibited area 630 including the obstacle 620 that is not sensed by the LiDAR sensor of the robot 100. Here, the prohibited area 630 may be set by the user. More specifically, the user may also recognize a location of the obstacle 620 via the camera view 610 in FIG. 10C. In this regard, the user may set an area around the obstacle 620 as the prohibited area 630 such that the robot 100 travels by avoiding the obstacle 620. To this end, the user may drag and drop the area around the obstacle 620 with the mouse. Here, an embodiment of setting the prohibited area 620 will be described once more in FIG. 12B.

Accordingly, the control system of the robot may set the virtual barrier and modify the short-range route plan of the robot 100.

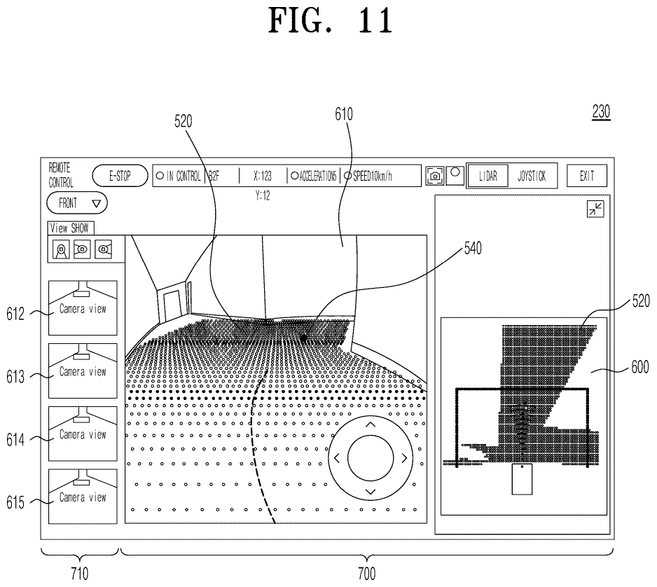

FIG. 11 is a diagram illustrating a user interface output by a control system of a robot according to an embodiment of the present disclosure. Hereinafter, a description redundant with the above-described content will be omitted.

Referring to FIG. 11, a diagram illustrating a user interface that the control system of the robot outputs on the display 230. The user interface may include both the 2D LiDAR view 600 and the camera view 610 representing the travelable area 520 of the robot.

In an embodiment, the control system of the robot may control at least one robot at a time. To this end, the user interface may output the 2D LiDAR view 600 and the camera view 610 of a first robot in a main area 700. The user may select the destination 540 using the camera view 610 and the 2D LiDAR view 600 output in the main area 700. When the destination 540 is selected by the user, the control system of the robot may output the expected route to the destination 540 in consideration of the current location of the robot and various data. This is as described above.

In an embodiment, the control system of the robot may output second to fifth camera views 612, 613, 614, and 615 of second to fifth robots, not the first robot, in an auxiliary area 710. In this regard, the user may select one camera view from among the second to fifth camera views 612, 613, 614, and 615, and the control system of the robot may output the selected camera view and a 2D LiDAR view corresponding to the selected camera view in the main area 700.

Accordingly, the user may easily control several robots, not one robot, at once.

FIGS. 12A and 12B are diagrams illustrating a user interface output by a control system of a robot according to another embodiment of the present disclosure. Hereinafter, a description redundant with the above-described content will be omitted.

FIG. 12A illustrates the display 230 of the control system of the robot outputting the main area 700 including the 2D LiDAR view 600 and the camera view 610, and FIG. 12B illustrates an embodiment of setting the prohibited area 630 in the user interface.

Referring to FIG. 12A, in the state in which the destination 540 of the robot is set, the user may sense the obstacle 620 that is not sensed by the robot via the camera view 610. In this case, the user may set the prohibited area 630 including the obstacle 620 through the method in FIG. 12B. In this regard, the method of setting the prohibited area 630 including the obstacle 620 includes not only the method in which the user directly specifies the prohibited area 630 by the dragging and dropping, but also a method in which, when the user clicks the obstacle 630 instead of the destination 540, the control system of the robot senses the same in the camera view 610 of the obstacle 630 and automatically sets a first distance range from the obstacle 630 as the prohibited area 630.

In an embodiment, the control system of the robot may modify the expected movement route 550 of the robot based on user setting.

Referring to (a) in FIG. 12B, the user may output a menu list 810 via a first input signal (e.g., a mouse right click) 800 while the robot 100 is traveling. Here, the menu list 810 may include a prohibited area setting menu 811 and a movement menu 812. When the user selects the movement menu 812, the control system of the robot may move the robot 100 to a point corresponding to the first input signal input by the user.

When the user selects the prohibited area setting menu 811, as shown in (b) in FIG. 12B, the user may input the prohibited area via a second input signal (e.g., a mouse drag and drop) 820. Accordingly, referring to (c) in FIG. 12B, the control system of the robot may set the prohibited area 630 based on the second input signal 820 of the user.

The components of the robot and the control system of the robot according to the embodiments described in FIGS. 1 to 12B may be implemented by hardware including one or more processors coupled with a memory, software, firmware, or a combination thereof. The components of the device according to the embodiments may be implemented as one chip, for example, one hardware circuit. In addition, the components of the electric toothbrush for the companion animals according to the embodiments may be implemented as separate chips, respectively. In addition, at least one of the components of the electric toothbrush for the companion animals according to the embodiments may be configured with one or more processors capable of executing one or more programs, and the one or more programs may include instructions for performing one or more operations among the operations/methods of the robot and the control system of the robot described with reference to FIGS. 1 to 12B.

Although the drawings have been described separately for convenience of description, the embodiments described in the drawings may also be designed to be merged together to implement a new embodiment. In addition, in accordance with needs of a person skilled in the art, designing a computer-readable recording medium in which a program for executing the embodiments described above is recorded also belongs to the scope of the embodiments. The configurations and the methods of the embodiments described above may not be limitedly applied to the device according to the embodiments, and all or some of the embodiments may be combined together such that various modifications may be made. Although the preferred embodiment among the embodiments has been illustrated and described, the embodiments are not limited to the specific embodiment described above, various modifications may be made by a person skilled in the art to which the present disclosure belongs without departing from the gist of the embodiments claimed in the claims, and such modifications should not be individually understood from the technical idea or prospect of the embodiments. The descriptions of the device according to the embodiments may be applied by supplementing each other.

Various components of the device according to the embodiments may be constructed by hardware, software, firmware, or a combination thereof. The various components of the embodiments may be implemented as one chip, for example, one hardware circuit. According to the embodiments, the components according to the embodiments may be implemented as separate chips. According to the embodiments, at least one of the components of the device according to the embodiments may be implemented with one or more processors capable of executing one or more programs, and the one or more programs may include instructions for performing one or more of the operations/methods according to the embodiments.

In the present document, “/” and “,” are interpreted as “and/or”. For example, “A/B” is interpreted as “A and/or B”, and “A, B” is interpreted as “A and/or B”. Additionally, “A/B/C” means “at least one of A, B, and/or C”. In addition, “A, B, C” also means “at least one of A, B, and/or C”. Additionally, “or” in the present document is interpreted as “and/or”. For example, “A or B” may mean 1) only “A”, 2) only “B”, or 3) “A and B”. In other words, “or” in the present document may mean “additionally or alternatively”.

Terms such as first, second, and the like may be used to describe the various components of the embodiments. However, interpretation of the various components according to the embodiments should not be limited by the above terms. These terms are merely used to distinguish one component from another. For example, a first user input signal may be referred to as a second user input signal. Similarly, the second user input signal may be referred to as the first user input signal. The use of such terms should be interpreted as not departing from the scope of the various embodiments. Both the first user input signal and the second user input signal are the user input signals, but do not mean the same user input signal unless clearly indicated in the context.

The terms used to describe the embodiments are used for the purpose of describing the specific embodiments and are not intended to limit the embodiments. As used in the description of the embodiments and the claims, the singular expression is intended to include the plural expression unless clearly stated in the context. The expression of “and/or” is used in the sense of including all possible combinations of the terms. The expression of “include” describes that features, numbers, steps, elements, and/or components are present, and does not mean not including additional features, numbers, steps, elements, and/or components. Conditional expressions such as “in case of” and “when” used to describe the embodiments are not limitedly interpreted as optional cases. It is intended to perform a related operation in response to the specific condition or to interpret a related definition when a specific condition is satisfied.

### Industrial Applicability

Because the present disclosure may be repeatedly implemented in the robot, the control system of the robot, and the control method of the robot, there is an industrial applicability.

What is claimed is:

1. A system for controlling a robot, the system comprising:
a display configured to output a screen;
a communicator configured to transmit and receive data to and from at least one robot;
an inputter configured to receive an input signal from at least one input device; and
a processor configured to control the display, the communicator, and the inputter,
wherein the processor is configured to:
determine whether to apply a remote assisted driving mode included in a remote driving mode when receiving a request for the remote driving mode from the robot;
receive a current state of the robot and sensor data measured by the robot from the robot when the remote assisted driving mode is applied;
output a travelable area of the robot on the display based on LiDAR sensor data included in the sensor data;
receive a destination of the robot from a user via the input device;
calculate a linear velocity and an angular velocity for moving the robot to the destination based on the current state of the robot and the sensor data;
predict a route based on the linear velocity and the angular velocity;
output the predicted route on the display; and
transmit a travel command to the robot based on velocity data including the linear velocity and the angular velocity.

2. The system of claim 1, wherein the processor is configured to predict the route based on data collected via an odometry sensor included in the robot, a dynamic state of the robot, and a delay state of the robot.

3. The system of claim 1, wherein the processor is configured to:
receive a prohibited area from the user; and
transmit the travel command to the robot based on the prohibited area.

4. The system of claim 1, wherein the route is a route travelable by the robot within a first time period based on a size of the robot and the velocity data.

5. The system of claim 1, wherein the processor is configured to generate the travelable area using Bresenham's line algorithm and a flood fill algorithm.

6. The system of claim 1, wherein the processor is configured to periodically check a state of communication with the robot.

7. The system of claim 6, wherein the processor is configured to perform at least one of a hole punching process, a heartbeat transmission/reception process, and a process of checking a response time for a delay characteristic message to check the state of communication with the robot.

8. The system of claim 6, wherein the processor is configured to stop receiving image data from the robot when the state of communication with the robot is an abnormal state.

9. The system of claim 6, wherein the processor is configured to limit a maximum velocity of the robot when the state of communication with the robot is an abnormal state.

10. The system of claim 1, wherein the processor is configured to:
control the robot in a remote manual driving mode when the input device is a joystick, wherein the remote manual driving mode is included in the remote driving mode; and
control the robot in the remote assisted driving mode when the input device is a mouse or a keyboard.

11. A method for controlling a robot, the method comprising:
requesting a remote driving mode;
determining whether to apply a remote assisted driving mode included in the remote driving mode;
receiving a current state of the robot and sensor data measured by the robot from the robot when the remote assisted driving mode is applied;
outputting a travelable area of the robot based on LiDAR sensor data included in the sensor data;
receiving a destination of the robot from a user;
calculating a linear velocity and an angular velocity for moving the robot to the destination based on the current state of the robot and the sensor data;
predicting a route based on the linear velocity and the angular velocity;
outputting the predicted route; and
transmitting a travel command to the robot based on velocity data including the linear velocity and the angular velocity.

12. A robot comprising:
a sensor configured to collect sensor data;
a communicator configured to transmit and receive data to and from a system for controlling the robot; and
a processor configured to control the sensor and the communicator,
wherein the processor is configured to:
request a remote driving mode from the control system of the robot;
transmit the collected sensor data to the control system of the robot; and
travel based on a linear velocity and an angular velocity included in velocity data received from the control system of the robot.
